(19) United States
(12) Patent Application Publication
(10) Pub. No.: US 2023/0231240 A1
(43) Pub. Date: Jul. 20, 2023

(54) ELECTROCHEMICAL CELLS

(71) Applicant: Charge CCCV LLC, Vestal, NY (US)

(72) Inventors: Vishnu Veeraraghavan, Johnson City, NY (US); Shailesh Upreti, Vestal, NY (US)

(21) Appl. No.: 18/099,739

(22) Filed: Jan. 20, 2023

Related U.S. Application Data
(60) Provisional application No. 63/301,237, filed on Jan. 20, 2022.

(51) Int. Cl. H01M 50/15; H01M 50/209; H01M 50/503; H01M 50/566; B60L 50/64; B60L 50/60

(52) U.S. Cl. CPC H01M 50/15; H01M 50/209; H01M 50/503; H01M 50/566; B60L 50/64; B60L 50/66; H01M 2220/20

(57) ABSTRACT

An electrochemical cell includes a housing defining an interior space of the electrochemical cell; and a lid disposed on a first face of the electrochemical cell defined by a length and a thickness of the housing. A dimension of the housing extending perpendicular to the first face of the electrochemical cell is a height of the housing, and the length of the housing is greater than the height of the housing. An anode and a cathode are disposed in the interior space of the electrochemical cell, and at least one of the anode or the cathode is connected to the lid.

### CLAIM OF PRIORITY

This application claims priority to U.S. Patent Application Ser. No. 63/301,237, filed on Jan. 20, 2022, the contents of which are incorporated here by reference in their entirety.

### FIELD OF THE DISCLOSURE

This disclosure relates to electrochemical cells.

### BACKGROUND

An electrochemical cell is a source of electric current that converts chemical energy into electrical energy and vice-versa. The electrochemical cell includes a positive terminal and a negative terminal, through which the current flows in and out during the charge and discharge processes of the electrochemical cell. For instance, lithium-ion, sodium ion, nickelhydrogen, lithium-air, lithium sulphur and other electrochemical cells are widely used in vehicles, personal computers, laptops, as they are lightweight and offer enhanced energy and power density.

### SUMMARY

We describe here an electrochemical cell, e.g., a prismatic electrochemical cell, having anode layers and cathode layers disposed in its interior. For instance, the anode and cathode layers can be provided as an electrode stack or jelly roll including alternating anode and cathode layers. The anode and cathode layers are connected to terminals on respective lids, e.g., at opposite ends of the electrochemical cell. The lids are disposed at opposite ends of the electrochemical cell separated by a height of the cell. The length of the cell, which is orthogonal to the height, is greater than the height. Because current travels in the smaller, height direction, these electrochemical cells operate quickly and with high efficiency.

The anode and cathode layers are connected to the terminals on the lids via a direct physical and electrical connection, e.g., a tab-less connection. For instance, the anode layers are formed of a metal substrate (e.g., a foil) coated with an anode active material. Similarly, the cathode layers are formed of a metal substrate (e.g., a foil) coated with a cathode active material. An uncoated portion of the foils are in direct physical and electrical contact with the interior surface of the respective lid. This direct connection provides low resistance, facilitating fast charging and discharging of the electrochemical cell.

The electrochemical cells described here also can include a thermal management module formed on an interior surface of one or both lids, e.g., the lid connected to the anode layers, the lid connected to the cathode layers, or both. The thermal management module includes one or more fluid channels defined in the interior surface of the lid. Fluid flowing through the fluid channels regulates the thermal environment of the electrochemical cell, e.g., cooling or heating the electrochemical cell.

In a first aspect, an electrochemical cell includes a housing defining an interior space of the electrochemical cell; and a lid disposed on a first face of the electrochemical cell defined by a length and a thickness of the housing. A dimension of the housing extends perpendicular to the first face of the electrochemical cell is a height of the housing, and the length of the housing is greater than the height of the housing. The electrochemical cell includes an anode and a cathode disposed in the interior space of the electrochemical cell, at least one of the anode or the cathode connected to the lid.

Embodiments can include one or any combination of two or more of the following features.

The lid is a first lid, and the electrochemical cell includes a second lid disposed on a second face of the electrochemical cell opposite the first face, the second lid separated from the first lid by the height of the housing, and in which the anode is connected to the first lid and the cathode is connected to the second lid.

A ratio between the length of the housing and the height of the housing is greater than 1 and less than 40.

The height of the housing is less than 500 mm, e.g., less than 125 mm.

The length of the housing is at least 100 mm, e.g., greater than 500 mm, e.g., greater than 1 meter.

The electrochemical cell is configured such that current flow in the electrochemical cell is substantially in a direction parallel to the height of the electrochemical cell.

The lid includes multiple electrically conductive sections, in which each first section is electrically isolated from each other section. In some cases, in which the anode includes multiple anode elements, in which a corresponding subset of the anode elements is connected to each section of the lid. In some cases, the cathode includes multiple cathode elements, in which a corresponding subset of the cathode elements is connected to each section of the lid. In some cases, multiple sub-cells are defined within the interior of the space of the electrochemical cell, each sub-cell containing a respective subset of the anode elements and a respective subset of multiple cathode elements of the cathode. In some cases, each sub-cell is fluidically isolated from each other of sub-cell. In some cases, at least one sub-cell has a performance characteristic that differs from a performance characteristic of one or more other of the sub-cells. In some cases, at least one sub-cell is controllable independently from one or more other of the sub-cells.

A fluid channel is defined on an inner surface of the lid.

The anode includes a metal substrate extending along the height of the electrochemical cell; and an anode material coated on a portion of a surface of the metal substrate, and in which an uncoated portion of the metal substrate is in contact with an inner surface of the lid.

The cathode includes a metal substrate extending along the height of the electrochemical cell; and a cathode material coated on a portion of a surface of the metal substrate, and in which an uncoated portion of the metal substrate is in contact with an inner surface of the lid.

In a second aspect, a battery pack includes an array of any the electrochemical cells of the first aspect.

Embodiments can include one or any combination of two or more of the following features.

The electrochemical cells in the array are arranged such that a largest face of each electrochemical cell faces a largest face of an adjacent electrochemical cell.

The lid includes a first lid to which the anode is connected, and in which each electrochemical cell includes a second lid disposed on a second face of the electrochemical cell opposite the first face, in which the cathode is connected to the second lid. The electrochemical cells in the array are arranged such that the first lid of a first electrochemical cell in the array faces in a first direction, and the first lid of an adjacent electrochemical cell in the array faces in a second direction opposite the first direction.

The battery pack is disposed in a vehicle. In some cases, the battery pack is disposed in the vehicle such that the length of the electrochemical cells in the battery pack is oriented parallel to an axle of the vehicle.

In a third aspect, combinable with the first or second aspect, an electrochemical cell includes a housing defining an interior space of an electrochemical cell, the housing defining one or more sides of the electrochemical cell. An inner surface of each of the one or more sides faces the interior space of the electrochemical cell. The electrochemical cell includes an anode and a cathode disposed in the interior space of the electrochemical cell; a lid having an inner surface facing the interior space of the electrochemical cell, in which the anode, the cathode, or both are connected to the lid; and a thermal management module disposed on the inner surface of one or more of the sides of the electrochemical cell, the inner surface of the lid, or both.

Embodiments can include one or any combination of two or more of the following features.

The thermal management module includes a fluid channel; and an inlet port and an outlet port fluidically connected to the fluid channel.

The fluid channel has a serpentine configuration or a linear configuration.

The fluid channel extends in a direction perpendicular to a height of the electrochemical cell or in a direction perpendicular to a length of the electrochemical cell.

The fluid channel is configured to receive a thermal management fluid.

A diameter of the fluid channel is at least 100 μm.

The thermal management module includes a metal tube defining the fluid channel.

The electrochemical cell including a passive cooling element disposed at an exterior of the electrochemical cell, in which the fluid channel extends through the passive cooling element. In some cases, the passive cooling element includes a fin.

The fluid channel is defined on an interior wall of the electrochemical cell, the interior wall including the inner surface of one of the sides of the electrochemical cell or the inner surface of the lid of the electrochemical cell.

The inlet port and the outlet port are defined in the side of the electrochemical cell or the lid of the electrochemical cell in which the fluid channel is defined. In some cases, the inlet port and the outlet port are defined on a same end of the side or lid in which the fluid channel is defined. In some cases, the inlet port and the outlet port are defined on opposite ends of the side or lid in which the fluid channel is defined.

The thermal management module includes a second fluid channel defined on a second interior wall of the electrochemical cell, the second interior wall including the inner surface of one of the sides of the electrochemical cell or the inner surface of the lid, and in which the second interior wall is different from the first interior wall.

The thermal management module includes multiple fluid channels defined on the same interior wall.

The interior wall includes a metal.

An area of the interior wall occupied by the fluid channel is between 25% and 90% of a total surface area of the interior wall.

The fluid channel is defined on the inner surface of the lid, and in which the anode, the cathode, or both are directly connected to the inner surface of the lid.

The thermal management module includes a thermoelectric cooling system.

The lid includes a first lid. The electrochemical cell includes a second lid having an inner surface facing the interior space and opposite the inner surface of the first lid, in which the anode is connected to the first lid and the cathode is connected to the second lid.

In a fourth aspect, combinable with any of the first through third aspects, a method of making an electrochemical cell includes disposing an anode and a cathode in an interior space defined by a housing, the housing defining one or more sides of the electrochemical cell, in which an inner surface of each of the one or more sides faces the interior space of the electrochemical cell. The method includes connecting a lid to the housing such that an inner surface of the lid defines a wall of the interior space, including connecting the anode, the cathode, or both to the lid. A thermal management module is disposed on the inner surface of one or more of the sides of the electrochemical cell, on the inner surface of the lid, or both.

Embodiments can include one or any combination of two or more of the following features.

The method includes forming the fluid channel in the inner surface of one or more of the sides of the electrochemical cell, the inner surface of the lid, or both. In some examples, forming the fluid channel includes fabricating the housing, the lid, or both using an additive manufacturing process. In some examples, forming the fluid channel includes fabricating the housing, the lid, or both using molding.

In a fifth aspect, combinable with any of the first through fourth aspects, a method of operating an electrochemical cell includes generating an electric current from the electrochemical cell including an anode and a cathode disposed in an interior space of the electrochemical cell, in which the anode, the cathode, or both are connected to a lid having an inner surface defining a wall of the interior space of the electrochemical cell; and flowing a fluid into an inlet port, through a fluid channel defined on an inner surface of one or more of the sides of the electrochemical cell, the inner surface of the lid, or both, and out of an outlet port.

Embodiments can include one or any combination of two or more of the following features.

Flowing the fluid includes cooling the electrochemical cell or heating the electrochemical cell.

Flowing the fluid includes flowing a liquid, a gas, or a mixture of liquid and gas.

In a sixth aspect, combinable with any of the first through fifth aspects, an electrochemical cell includes a housing defining an interior space of the electrochemical cell; a lid having an inner surface facing the interior space of the electrochemical cell, the lid extending along a length of the electrochemical cell; and an electrode disposed in the interior space of the electrochemical cell and electrically connected to the lid. The electrode includes a metal substrate extending along a height of the electrochemical cell, and an anode material or a cathode material coated on a portion of a surface of the metal substrate, in which an uncoated portion of the metal substrate is in contact with the inner surface of the lid.

Embodiments can include one or any combination of two or more of the following features.

The electrode is welded to the inner surface of the lid.

A groove is defined in the inner surface of the lid, and in which the uncoated portion of the metal substrate is disposed in the groove. In some cases, the groove extends along the length of the electrochemical cell. In some cases, the electrochemical cell includes multiple electrodes and in which multiple grooves are defined in the inner surface of the lid, and in which the uncoated portion of the metal substrate of each electrode is disposed in a corresponding one of the grooves.

The uncoated portion of the metal substrate includes protrusions that extend in a direction of a thickness of the electric cell. In some cases, the protrusions define a plane parallel to a plane of the inner surface of the lid. In some cases, the protrusions contact the inner surface of the lid.

The electrochemical cell includes multiple anodes, each anode including an anode material coated on a portion of the surface of a respective anode substrate; and multiple cathodes, each cathode including a cathode material coated on a portion of the surface of a respective cathode substrate. In some cases, the multiple anode substrates each includes a protrusion extending in a first direction along a thickness of the electric cell such that the protrusion of a given anode substrate is over the protrusion of an adjacent anode substrate; and the multiple cathode substrates each includes a protrusion extending in a second direction along a thickness of the electrochemical cell such that the protrusion of a given cathode substrate is over the protrusion of an adjacent cathode substrate. In some cases, an outermost protrusion of the multiple anode substrates and an outermost protrusion of the multiple cathode substrates contact the inner surface of the lid.

The lid includes a first lid, and including a second lid having an inner surface facing the interior space of the electrochemical cell and opposite the inner surface of the first lid. In some cases, the electrode includes an anode, and including a second electrode including a cathode, in which the anode is electrically connected to the first lid and the cathode is electrically connected to the second lid.

A fluid channel is defined on the inner surface of the lid.

Particular implementations of the subject matter described in this specification can be implemented so as to realize one or more of the following technical advantages.

The electrochemical cells described here offer high power density and high energy density in a single unit as well as when these units are put together to build a larger unit such as battery pack. For instance, the electrochemical cells described here can be assembled into a pack to achieve an improvement in power density ranging between 100% to 1000% as compared to conventional electrochemical cells of the same footprint and same energy density cell, and also addresses the deficit occurring from cell to pack conversion. For instance, the electrochemical cells described here can be utilized to build batteries for delivering high cell to pack ratio and with high energy density at the pack level, e.g., anywhere ranging between 10% to 100% by weight and 5 to 95% by volume.

The electrochemical cells described here have lids that extend along the entire width of the cell unit, which provides a high surface area for electron transport and thermal equilibrium between the external and internal medium of the electrochemical cell. For instance, this high surface area facilitates super-fast charging and discharging, e.g., charging and discharging in a time frame ranging between 2 to 45 minutes.

The electrochemical cells described here have direct, tab-less connections between the current collectors (e.g., anodes and cathodes) and terminals. These direct, tab-less connections are capable of handling, e.g., between 10% and 100% of operational current without generating heat above 100% of the operating temperature.

In the electrochemical cells described here, the current flow and heat dissipation flow are perpendicular to the longest dimension of the electrochemical cell, which shortens the current and thermal path for an effective battery pack without sacrificing energy density while delivering higher power and temperature controlling features of the electrochemical cell. For instance, these performance parameters can be achieved in a temperature range from 0° C. to 200° C. with below 10% loss in cycle life of the battery cell. This configuration also can allow batteries to work in a temperature range from −100° C. to 400° C. without sacrificing performance.

The details of one or more embodiments are set forth in the accompanying drawings and the description below. Other features and advantages will be apparent from the description and drawings, and from the claims.

### DESCRIPTION OF DRAWINGS

FIGS. 1A and 1B are exploded perspective views of an electrochemical cell.

FIGS. 1C and 1D are exploded perspective views of electrochemical cells.

FIG. 2 is a cross-sectional view of an electrochemical cell.

FIGS. 3A and 3B are exploded perspective views of electrochemical cells.

FIGS. 4A and 4B are exploded perspective views of arrays of electrochemical cells.

FIGS. 5A-5C are diagrams of a pack of electrochemical cells.

FIGS. 6A and 6B are exploded perspective and side views, respectively, of a lid of an electrochemical cell.

FIG. 7 is a perspective view of an electrochemical cell.

FIG. 8A is a perspective views of a portion of a lid of an electrochemical cell.

FIG. 8B is a perspective view of an electrochemical cell.

FIGS. 9 and 10 are perspective views of electrochemical cells.

FIG. 11A is an exploded end view of a portion of an electrochemical cell.

FIGS. 11B and 11C are end and perspective views, respectively, of a portion of an electrochemical cell.

FIGS. 12A and 12B are top and perspective views, respectively, of current collectors of an electrochemical cell.

FIGS. 13A and 13B are side and perspective views, respectively, of current collectors of an electrochemical cell.

FIG. 14 is a view of an electrochemical cell and an array of cylindrical cell.

In the figures, like references indicate like elements.

### DETAILED DESCRIPTION

We describe here an electrochemical cell, e.g., a prismatic cell, having anode layers and cathode layers disposed in its interior. For instance, the anode and cathode layers can be provided as an electrode stack or jelly roll including alternating anode and cathode layers. The anode and cathode layers are connected to terminals on respective lids, e.g., at opposite ends of the electrochemical cell. The lids are disposed at opposite ends of the electrochemical cell separated by a height of the cell. The length of the cell, which is orthogonal to the height, is greater than the height. Because current travels in the smaller, height direction, these electrochemical cells operate quickly and with high efficiency.

These lids are defined by the largest dimension of the cell, the length, and thus provide a large surface area, which facilitates electrical conduction between the electrodes (e.g., anode and cathode layers) and external terminals, and also facilitates regulation of the thermal environment of the electrochemical cell.

The electrochemical cells described here can include a thermal management module formed on an interior surface of a housing of the electrochemical cells. For instance, a thermal management module can be incorporated into one or both lids, e.g., the lid connected to the anode layers, the lid connected to the cathode layers, or both; one or more sides of the housing; or a combination thereof. The thermal management module includes one or more fluid channels defined in the interior surface of the lid. Fluid flowing through the fluid channels regulates the thermal environment of the electrochemical cell, e.g., cooling or heating the electrochemical cell.

The connection between the anode layers and cathode layers and the respective lid is a direct, tab-less connection. For instance, the anode layers are formed of a metal substrate (e.g., a foil) coated with an anode active material. Similarly, the cathode layers are formed of a metal substrate (e.g., a foil) coated with a cathode active material. An uncoated portion of the foils are in direct physical and electrical contact with the interior surface of the respective lid. This direct connection provides low resistance, facilitating super-fast charging and discharging of the electrochemical cell.

As used herein, the following terminology applies to the descriptive dimensions of the electrochemical cell. Height is defined as in the direction of the terminals. Length and thickness (e.g., width) are orthogonal to the height, and thickness (e.g., width) is the smallest dimension. This convention applies regardless of which direction is the longest.

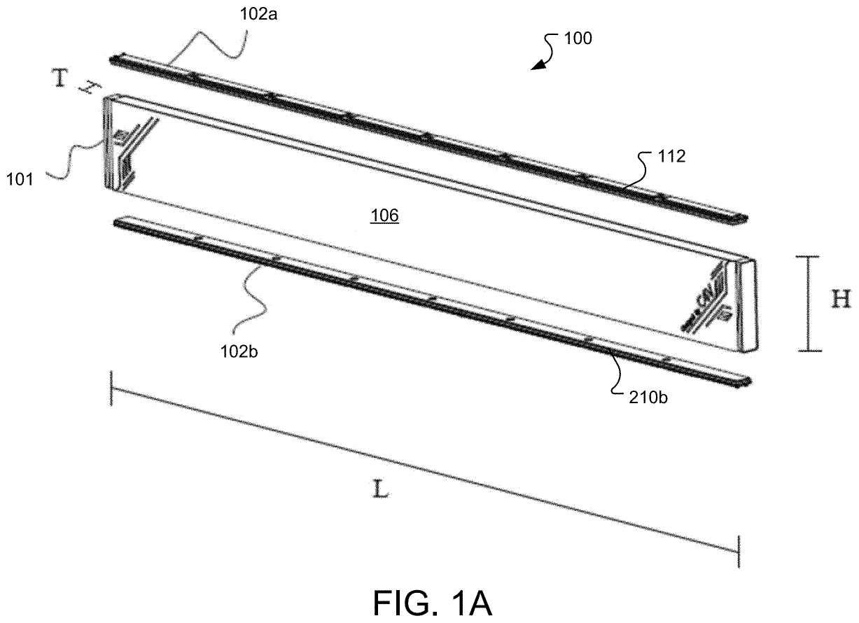

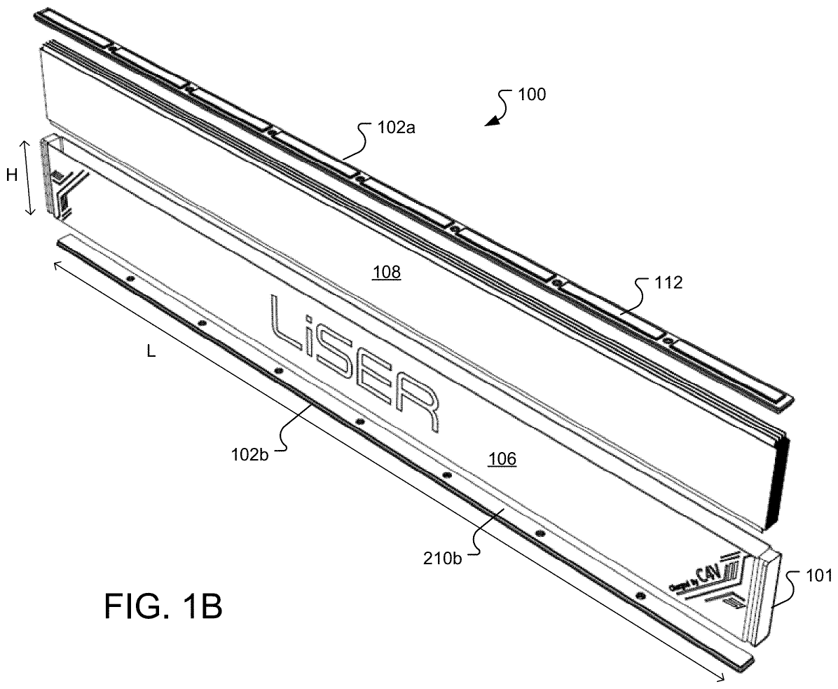

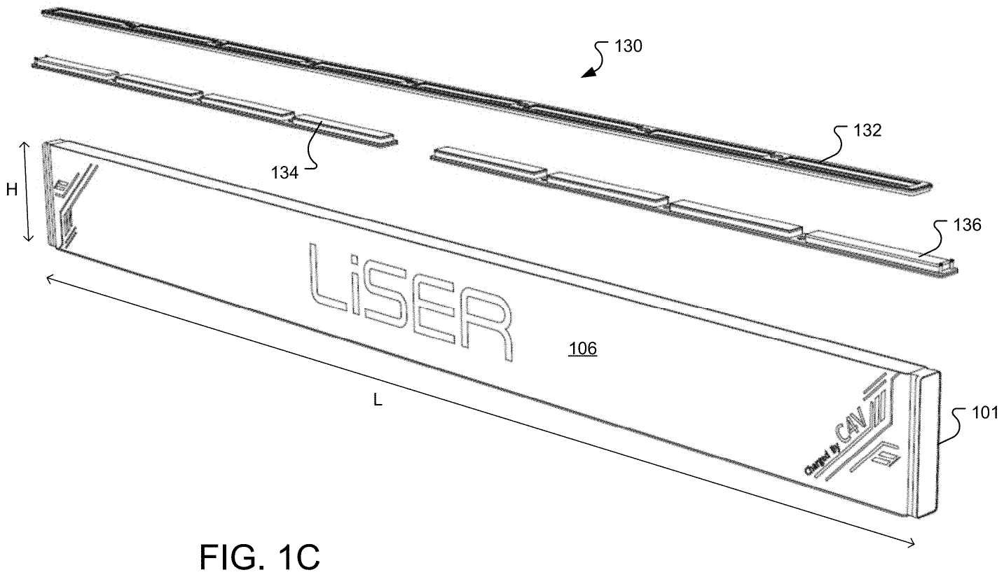

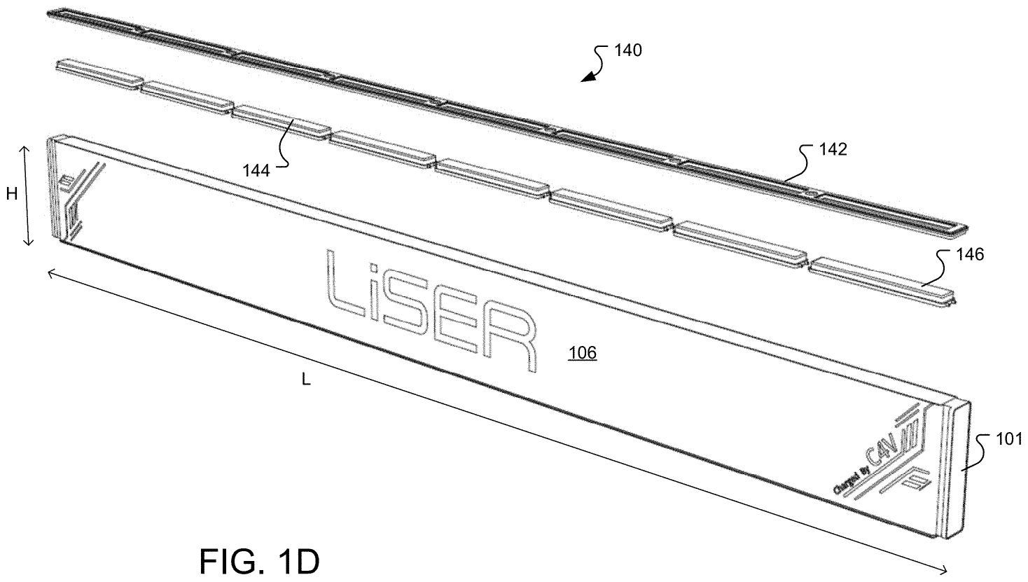

Referring to FIGS. 1A and 1B, an electrochemical cell 100, e.g., a prismatic cell, includes a cell housing 101 having orthogonal height H, and length L and thickness T. The length and height of the electrochemical cell 100 define front and rear faces 106 of the cell, which are the faces having the largest surface area. The length of the electrochemical cell is the longest dimension, e.g., the height and thickness are both less than the length.

In some examples, the length L of the electrochemical cell 100 is the largest dimension of the cell and is 100 mm or greater, e.g., 200 mm 500 mm or greater or 1000 mm or greater, e.g., between 100 mm to 2000 mm, between 200 mm and 1600 mm or between 200 mm to 800, e.g., about 100, about 200 mm, about 400 mm, about 600 mm, about 800 mm, about 1000 mm, or about 1600 mm. The height H, which is less than the length, is 500 mm or less, e.g., 250 mm or less or 125 mm or less, e.g., between 50 to 500 mm, between 70 mm and 250 mm, or between 80 mm and 125 mm, e.g., about 100 mm or about 125 mm. The ratio of the length L to the height H is greater than 1, e.g., between 1 and 40. The thickness T ranges, e.g., between 18 mm to 26 mm.

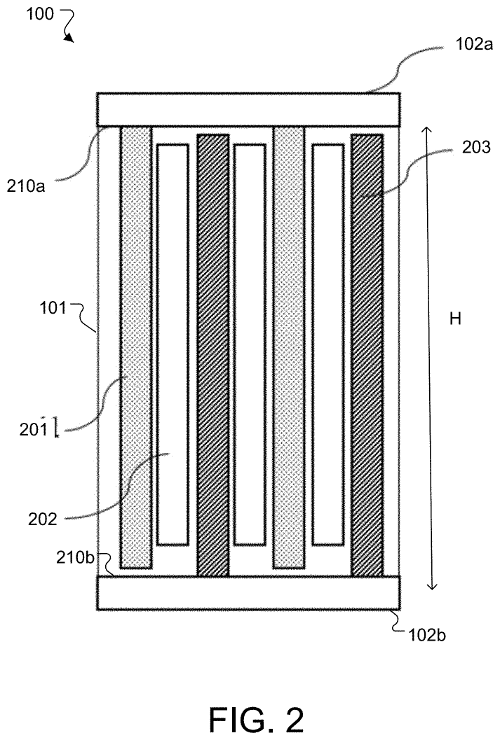

The electrochemical cell 100 includes two lids 102a, 102b (referred to collectively as lids 102). disposed at opposite ends of the electrochemical cell 100 and separated by the height H of the cell. An electrode stack 108 (see FIG. 1B) is disposed in an interior space of the housing 101. The electrode stack 108 includes at least one positive electrode and at least one negative electrode (a cathode layer 201 and an anode layer 203, respectively, as shown in FIG. 2), and a non-conducting separator layer (e.g., layer 202 as shown in FIG. 2) that is disposed between the positive and negative electrode layers.

The electrode assembly 108 is electrically connected to conductive terminals on one or both of the lids 102a, 102b. The connection of the electrode assembly 108 to one or both of the lids 102a, 102b means that current flow in the electrochemical cell is generally in the direction parallel to the height H of the electrochemical cell. Because the height H is not the largest dimension of the electrochemical cell 100, current in the cell has a short distance to flow before reaching a conductive terminal. This geometry facilitates fast and efficient charging and discharging and reduces the amount of heat generated in the electrochemical cell 100. Moreover, the distance of current flow is independent of the largest dimension of the electrochemical cell 100, e.g., if the cell length L is increased, the current still flows only the height H of the cell. This configuration allows the fast and efficient operation of the cells to be achieved even for large cell volumes.

In some examples, the negative electrode (e.g., the anode layer(s)) is electrically connected to the lid 102a and the positive electrode (e.g., the cathode layer(s) is electrically connected to the lid 102b. In these examples, the conductive terminal on the lid 102a extends along substantially the entire length of the inner surface of the lid 102a, and the conductive terminal on the lid 102b extends along substantially the entire length of the inner surface of the lid 102b.

The lid(s) 102 provide external electrical connections to the anode and cathode of the electrochemical cell, e.g., electrical connections are formed through the thickness of the lid(s) between the conductive terminals on the inner surface and external terminals 112 on an outer surface of the lid(s) 102. In some examples, the external terminals 112 extend through the thickness of the lid and thus also form the internal conductive terminals.

Referring to FIGS. 1C-1D, in some examples, both the negative electrode and the positive electrode are electrically connected to the same lid, e.g., the lid 102a. In these examples, the inner surface of the lid 102a includes one or more negative conductive terminals to which the negative electrode is connected, and one or more positive conductive terminals to which the positive electrode is connected, where the negative and positive terminals are separated from one another, e.g., along the length of the inner surface of the lid. Referring specifically to FIG. 1C, in an electrochemical cell 130, negative conductive terminals 134 on a lid 132 are adjacent to one another, and the positive conductive terminals 136 are adjacent to one another and spaced apart from the negative conductive terminals 134. Referring specifically to FIG. 1D, in an electrochemical cell 140, the terminals on a lid 142 alternate between positive conductive terminals 146 and negative conductive terminals 144.

The lids 102 also provide a hermetically sealed environment within the housing 101. The lids 102 can be connected to the housing 101 via any suitable method, e.g., welding, such as laser welding, ultrasonic welding; bonding; or other attachment methods.

FIG. 2 shows an example arrangement of the cathode layers 201, the anode layers 203, and the non-conducting separator layers 202 disposed in the interior of the housing 101 of the electrochemical cell 100. The interior space of housing 101 is filled with an ionic conductive material (e.g., electrolyte), such as a liquid or solid electrolyte materials. The cathode layers 201 and the anode layers 203 are composed of active materials coated on metal substrates (e.g., aluminum, copper), such as foils, mesh, foam, or other suitable substrates. The separator layers 202 are composed of non-conducting materials, e.g., porous materials, such as polymers (e.g., plastics), such as polyetheyl ethyl ketone (PEEK).

In the example of FIG. 2, the cathode layers 201 are electrically connected to one or more conductive terminals (not shown) on an inner surface 210a of the lid 102a, and the anode layers 203 are electrically connected to one or more conductive terminals (not shown) on an inner surface 210b of the opposing lid 102b. In this configuration, current flow is along the direction of the height of the electrochemical cell. Because the height is not the largest dimension of the cell, the electrons do not have a long distance to travel, and thus the electrochemical cell can operate quickly and efficiently, e.g., rapid charging and discharging, and with low heat generation.

In some examples, the cathode layers 201 and the anode layers 203 are both electrically connected to conductive terminals on the inner surface of the same lid (e.g., on the inner surface 210a of the lid 102a), and the conductive terminals to which the cathode layers 201 are connected are electrically isolated from the conductive terminals two which the anode layers 203 are connected.

The lids 102 extend along the surfaces defined by the length and thickness of the electrochemical cell. Because of the long length L of the electrochemical cell, these surfaces provide a high surface area, e.g., for electric connection and thermal dissipation. For instance, this high surface area reduces contact resistance between the anode and cathode layers and the conductive terminals on the lid(s), enabling efficient and fast operation. Additionally, because current flow is in the direction parallel to the height, and thus not along the longest dimension of the cell, the path for electron flow to the conductive terminals on the lid(s) is a short path, which also enables efficient and fast operation. Additionally, as discussed further below, a thermal management module occupying the interior surface of the one or both of the lid(s) is provided with a large surface area which facilitates heat transfer to or from the interior of the electrochemical cell.

The geometry of the electrochemical cell 100 is applicable to cell shapes other than the illustrated rectangular prism. For instance, this geometry can apply to cylindrical electrochemical cells with conductive terminals on one or both circular ends of the cylinder. In this example, the height of the cylinder (the distance between the circular ends) is less than the diameter of the cylinder.

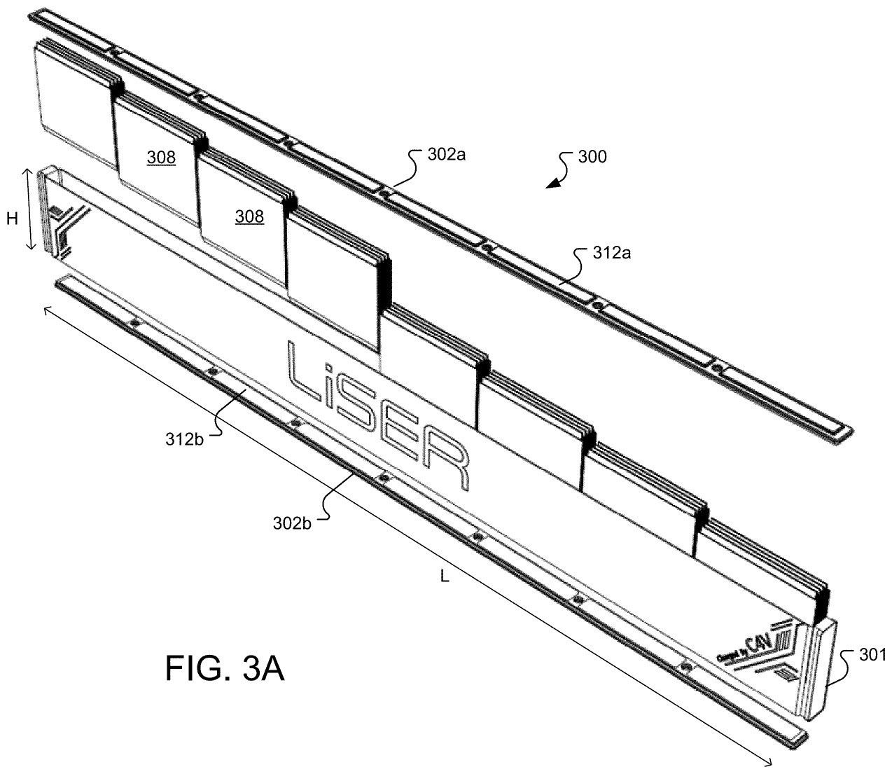

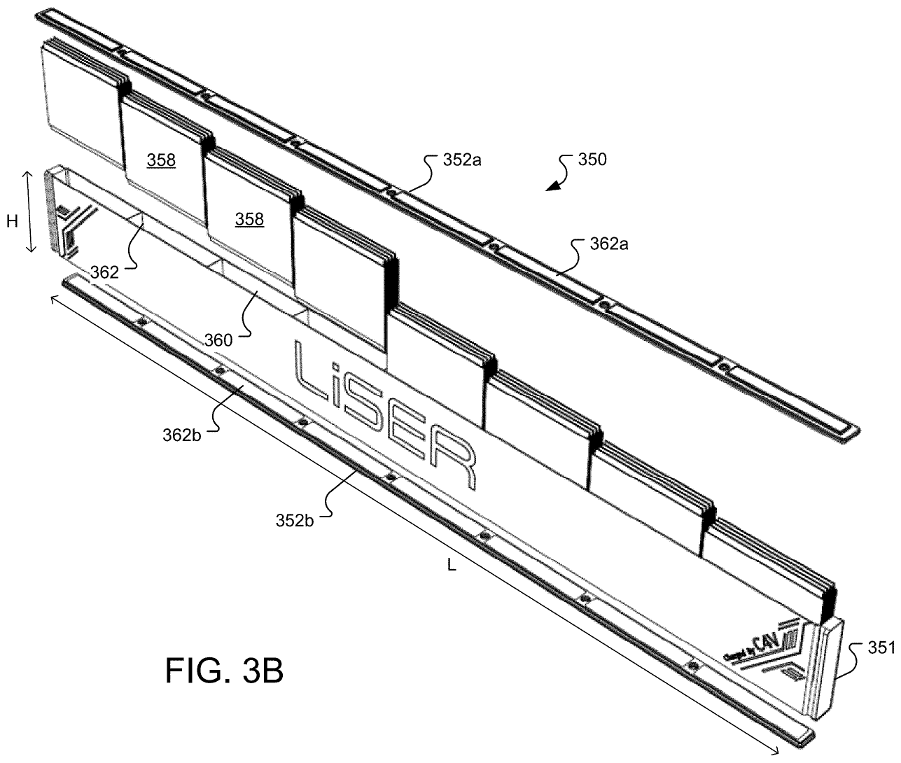

The electrochemical cell 100 of FIGS. 1A-1B includes single electrode stack 108 that extends along the entire length L of the electrochemical cell 100. Referring to FIGS. 3A-3B, in some examples, electrochemical cells include multiple electrode stacks disposed along the length of the electrochemical cell.

Referring specifically to FIG. 3A, an electrochemical cell 300 includes multiple electrode stacks 308 disposed in the interior space of a housing 301 and adjacent to one another along the length L of the cell. The electrode stacks 308 each have a structure such as that described above for the electrode stack 108, and each electrode stack 308 is electrically connected to a corresponding conductive terminal 312a on a lid 302a and to a corresponding conductive terminal 312b on a lid 302b of the electrochemical cell, although in some examples the electrode stacks 308 are connected to only a single lid, e.g., as discussed above. The conductive terminals 312a on the lid 302a are electrically isolated from one another, and the conductive terminals 312b on the lid 302 are also electrically isolated from one another. As with the electrochemical cell 100 of FIG. 1, the lids 302a, 302b are separated by the height H of the cell 300, which is less than the length L of the cell.

Each electrode stack 308 is operable as an electrochemical cell. The multiple electrode stacks 308 can be connected in series to provide a high voltage. For instance, if the electrochemical cell 300, with length L, had a single electrode stack, that electrochemical cell would be capable of producing a specified amount of voltage, e.g., 3.7 V. By incorporating multiple electrode stacks 308 into that same length L, the voltage available from the electrochemical cell is multiplied. For instance, the total voltage available is the voltage from an individual cell (e.g., 3.7 V) multiplied by the number of electrode stacks 308 in the electrochemical cell 300. This configuration thus allows for high voltage output even when space is limited.

The presence of multiple electrode stacks 308 (e.g., rather than a single electrode stack such as that illustrated in FIGS. 1A-1B) helps the electrochemical cell 300 to operate quickly and efficiently. For instance, current generated in a given electrode stack 308 does not have as far to travel as current generated in the single electrode stack 108 of FIG. 1.

Although the illustration of FIG. 3B shows the electrochemical cell 300 containing eight electrode stacks 308, other numbers of stacks are also possible, e.g., one, two, four, eight, or more than eight stacks.

Referring now to FIG. 3B, an electrochemical cell 350 includes multiple electrode stacks 358 disposed in the interior space of a housing 351 and adjacent to one another along the length L of the cell. The electrode stacks 358 each have a structure such as that described above for the electrode stack 108, and are electrically connected to respective conductive terminals 362a, 36b on lids 352a, 352b of the electrochemical cell, or to conductive terminals on a single lid. As with the electrochemical cell 100 of FIG. 1, the lids 352a, 352b are separated by the height H of the cell 300, which is less than the length L of the cell. The electrode stacks 358 provide similar advantages to those discussed above for the electrochemical cell 300 of FIG. 3A.

Each electrode stack 358 is disposed in a respective compartment 360 defined within the interior space of the housing 351. The compartments 360 are separated by walls 362 that provide fluidic and electrical isolation between adjacent compartments 360. This isolation allows sub-cells having individualized characteristics to be contained within the single electrochemical cell 350. For instance, some electrode stacks 358 can be designed for fast discharge while others can be designed for energy storage. In addition, the electrode stacks 358 can be controlled individually, e.g., turned off if overheating, or turned on if their characteristic is suited to environmental conditions. This isolation and individual control contributes to efficient operation. Furthermore, the isolation between electrode stacks can facilitate the production of high voltage from the multiple stacks, e.g., by avoiding potential negative impacts of high voltage in a single electrolyte (e.g., as in the configuration of FIG. 3A).

In the examples of FIGS. 3A and 3B, the orientation of the multiple electrode stacks 308, 358 can be the same across the entire length of the cell, or can alternate between adjacent electrode stacks. For instance, the electrode stacks 308, 358 can be oriented such that the cathode layers of all of the electrode stacks are electrically connected to the top lid 302a, 352a, and the anode layers of all of the electrode stacks are electrically connected to the bottom lid 302b, 352b. This alternating arrangement can be advantageous, e.g., when connecting the electrode stacks 308, 358 in series, e.g., in providing a shorter distance for current to travel between stacks.

The electrochemical cells described here can be assembled into an array, e.g., for use in a battery pack.

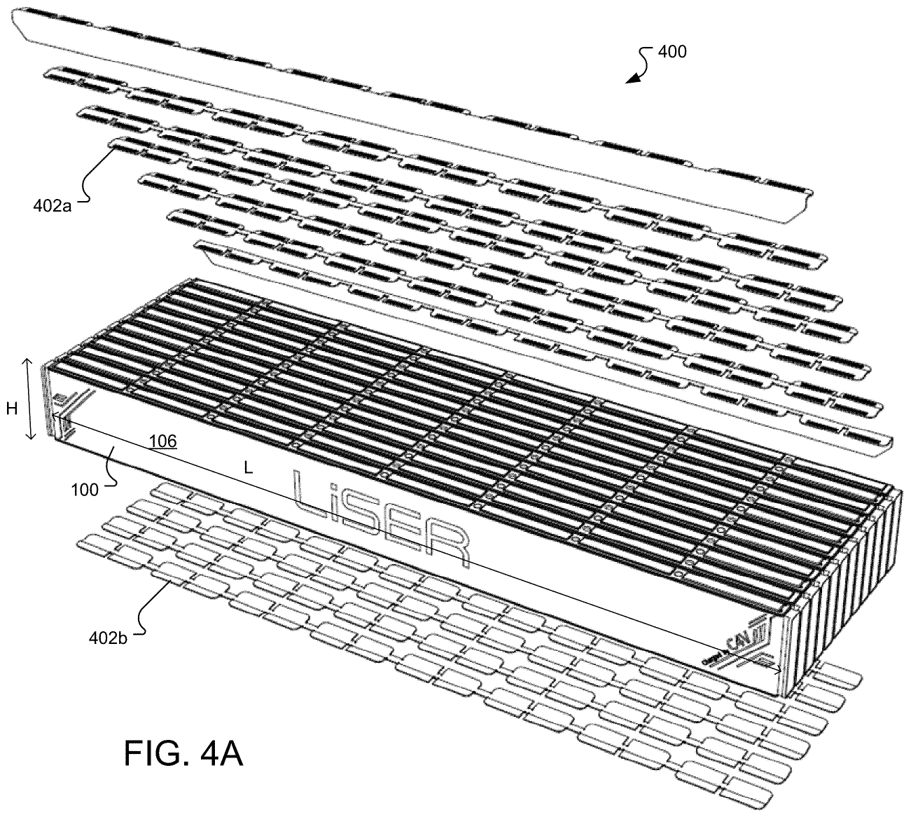

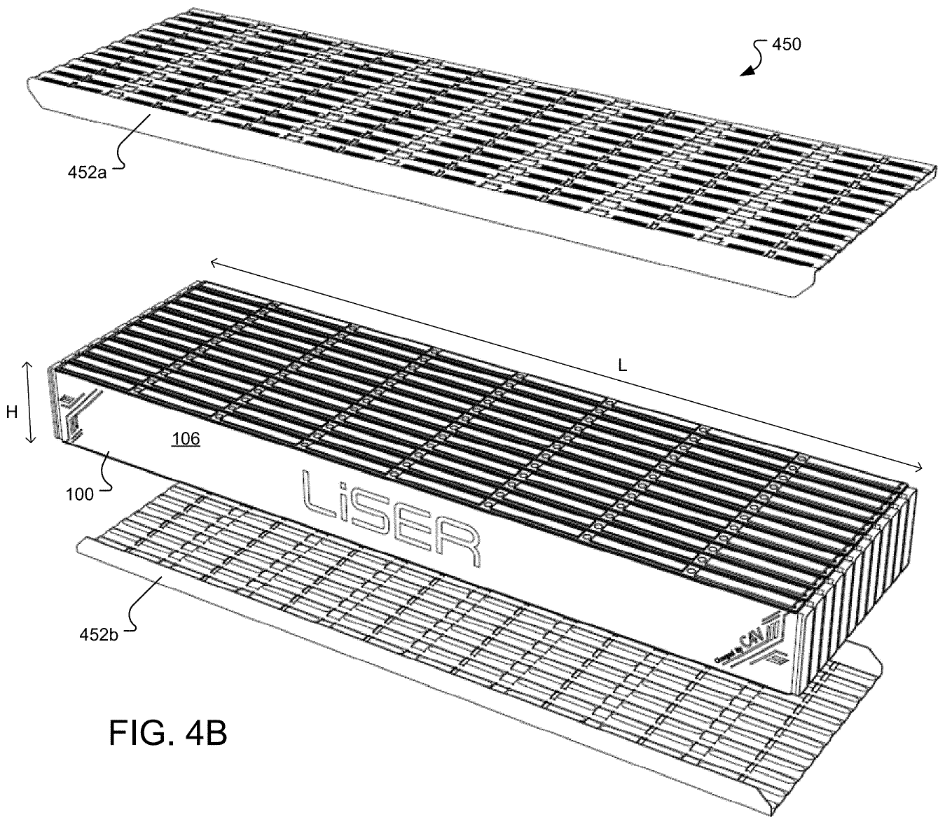

Referring to FIG. 4A, in an example, a series array 400 includes multiple electrochemical cells 100 arranged in an array and electrically connected in series. Although the electrochemical cells 100 are shown in FIG. 4A, any of the electrochemical cells described here can be used in such an array.

The electrochemical cells 100 are arranged such that the front face 106 of one cell faces the rear face of the adjacent cell. The elongated geometry of the electrochemical cells 100 allows the cells to be packed closely into the array 400, e.g., enabling a large number of cells to be included in a relatively compact space, e.g., enabling a battery pack including the array 400 to have high energy density.

External terminals 112 of the electrochemical cells are electrically connected via series connection bus bars 402a, 402b. The electrochemical cells 100 in the array 100 are arranged in alternating orientation, e.g., such that the lid 102a (e.g., the lid connected to the cathode layers) of one cell and the lid 102b (e.g., the lid connected to the anode layers) of an adjacent cell both abut the same series connection bus bar 402. This configuration enables the array to operate efficiently, e.g., because current has only a short distance to travel. In some examples, when both the positive and negative electrodes of the electrochemical cells are connected to the same lid of the cells, only a single series connection bus bar is used.

Referring to FIG. 4B, in an example, a parallel array 450 includes multiple electrochemical cells 100 arranged in an array and electrically connected in parallel. Although the electrochemical cells 100 are shown in FIG. 4A, any of the electrochemical cells described here can be used in such an array. External terminals 112 of the electrochemical cells are electrically connected via parallel connection bus bars 452a, 452b. The arrangement of the electrochemical cells 100 is, e.g., as described above for the array 400.

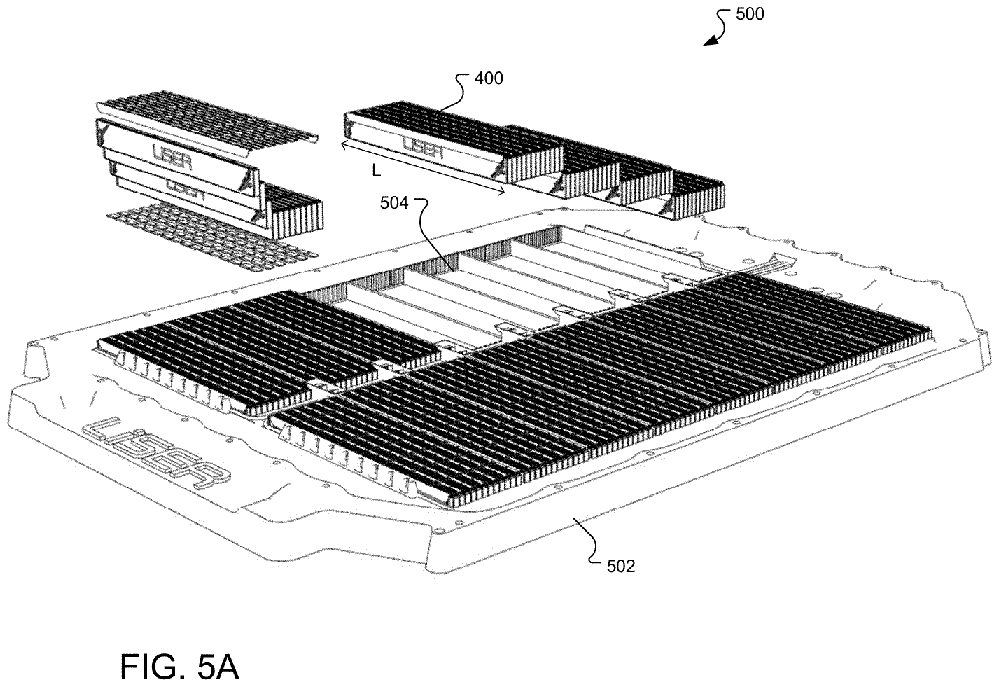

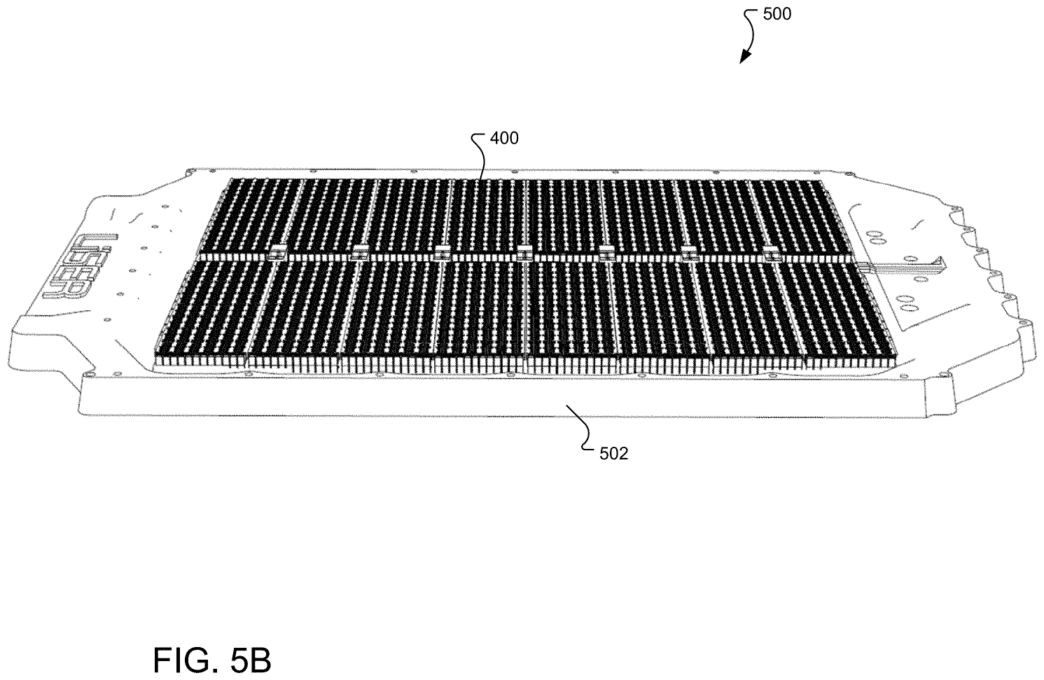

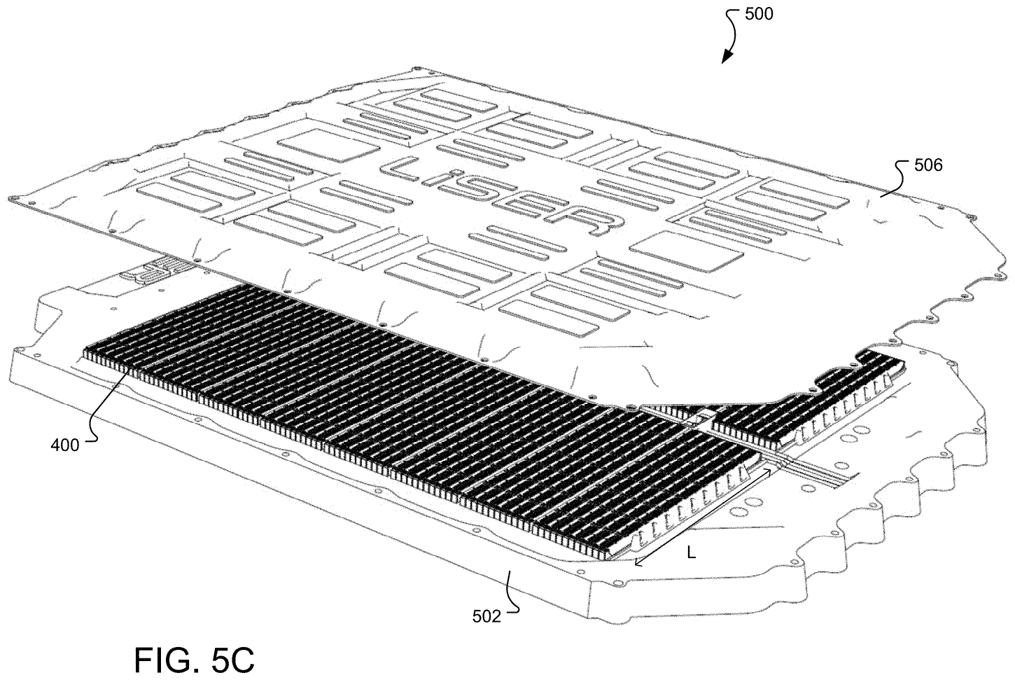

Referring to FIGS. 5A-5C, multiple arrays (e.g., series arrays 400, as shown, or parallel arrays, or a combination of both) are themselves assembled into an array to form a pack assembly 500. The pack assembly 500 includes a base 502 having compartments 504 to receive electrochemical cell arrays 400, and a lid 506 configured to fit over the base 502, thus defining an interior space within which the arrays 400 of electrochemical cells 100 are disposed.

The pack assembly 500 can be used in various contexts in which high energy density, fast charging and discharging, and/or other advantageous characteristics of the electrochemical cells 10 are relevant. In an example, the pack assembly 500 can be used as a power source for an electric vehicle, such as a car. For instance, the pack assembly 500 can be installed on the chassis of the car, and oriented such that the length L of the electrochemical cells 100 is parallel to the axles of the vehicle. Because the length of the electrochemical cells 100, the cells and/or the pack assembly 500 are similarly sized to the width of the chassis, and thus can provide structural support in addition to electric power.

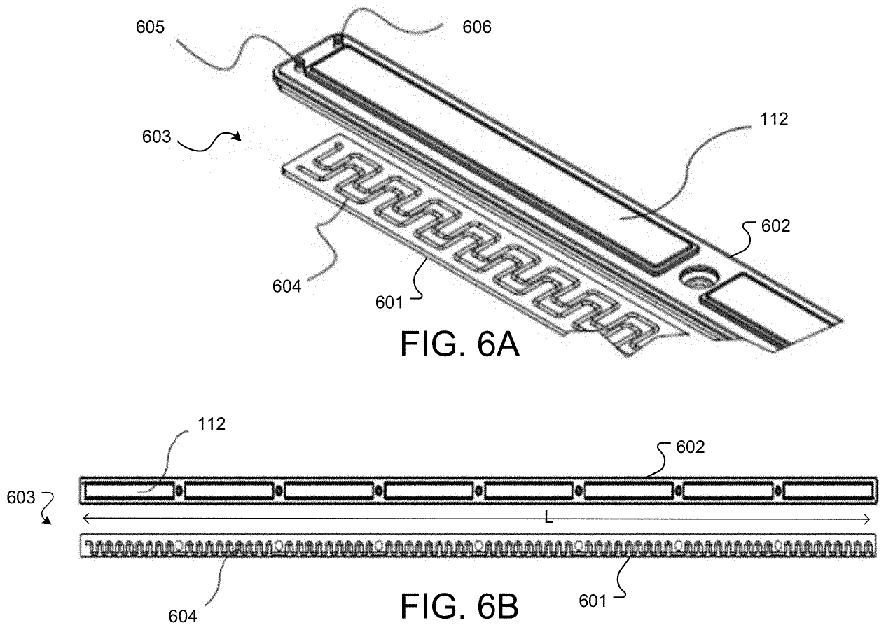

Referring to FIGS. 6A and 6B, in some examples, the electrochemical cells described here have thermal management capabilities integrated into one or both lids. For instance, an example lids 602 includes and a thermal management module 603 on its inner surface 601. The thermal management module 603 includes one or more fluid channels 604 defined on the inner surface 601 of the lid 602, e.g., such that the fluid channels 604 extend along a plane perpendicular to the height of the electrochemical cell (e.g., the height H of the electrochemical cell 100 of FIG. 1). Fluid can be circulated through the fluid channel(s) 604 to provide thermal management, e.g., to regulate (e.g., cool or heat) the material in the interior of the housing of the electrochemical cell (e.g., the housing 101 of the electrochemical cell 100 of FIG. 1). For instance, in warm environments, fluid is flowed through the thermal management module 603 to dissipate the heat generated by the electrochemical cell, whereas in cold environments, fluid is flowed the thermal management module 603 to add heat to the electrochemical cell, e.g., to enable efficient start-up operation of the electrochemical cell.

The thermal management module 603 is composed of a thermally and electrically conductive material, e.g., metal, such as steel, aluminum, copper, or alloys thereof. Forming the thermal management module 603 of an electrically conductive material allows the direct connection between the cathode layer (e.g., the cathode layer 201 and anode layer 203 of FIG. 2) and the respective thermal management module 603 to create an electrical pathway between the anode or cathode and external terminals 612 on the outer surface of the lid 602.

As shown in FIG. 6B, the fluid channels 604 defined on the inner surface 601 of the lid 602 are positioned such that fluid circulating through the fluid channels 604 comes into close physical proximity with the contents (e.g., electrolyte) in the interior of the housing of the electrochemical cell. The fluid channels 604 are fluidically separate from the interior of the electrochemical cell, e.g., there is no fluid exchange between the fluid channels 604 and the interior of the cell. One end of each of the channels 604 is connected to a corresponding outlet port 606, while the other end is connected to a corresponding inlet port 605.

A thermal exchange fluid, such as a liquid, gas, or combination thereof, can be provided into the fluid channels 604 through the inlet port 605, and recovered from the fluid channels 604 through the outlet port 606. Some examples of the thermal exchange fluid include water, air, or other suitable fluids (e.g., Glycol, mineral oils, etc.). In some examples, the thermal exchange fluid can be a slurry of particles suspended in a fluid, e.g., enabling rapid heat removal.

The number and configuration of the fluid channels 604 can depend on, e.g., the level of thermal management desired in the electrochemical cell. For example, the channels 604 can follow a serpentine path, a linear path, or a combination of serpentine and linear paths. The configuration of the fluid channels 604 can be such that a large portion of the surface area of the inner surface 601 of the lid 602 is occupied by the fluid channels 604, which facilitates efficient thermal exchange between the interior of the electrochemical cell and the fluid in the fluid channels 604. For instance, the area of the inner surface 601 of the lid 602 that is occupied by the fluid channels 604 can be, e.g., between 25% and 90% of a total surface area of the inner surface 601 of the terminal in the lid 602. The size (e.g., length, interior diameter, or both) of the fluid channels can be sized to allow a desired amount of fluid to flow therethrough, e.g., depending on the desired level of thermal management. For instance, the fluid channels 604 can have a diameter of at least about 100 μm, e.g., between about 100 μm and about 1 mm. The size of the fluid channels can be determined based on factors such as thermal management requirements, cost, and the size of the electrochemical cell.

The example inlet port 605 and outlet port 606 of FIG. 6A include threaded connections, though one or more other reversible (e.g., compressive connections) or irreversible (e.g., welded) connections can be made in alternative examples. The type of connection provided by the inlet port 605 and the outlet port 606 can depend on the type of exchange fluid. Liquid-tight connections can be used for a liquid exchange fluid, while gas-tight connections can be used for a gas exchange fluid.

In some examples, the thermal management module 603 is a standalone plate that is connected (e.g., by welding, brazing, adhesive, or another suitable method of connection) to a plate including the external terminals 612 to form the lid 602. In some examples, the thermal management module 603 is formed integrally with the external terminals 612, e.g., by molding (e.g., injection molding, compression molding, or another suitable molding technique), casting, additive manufacturing, or another suitable manufacturing technique. In some examples, the inlet port 605 and/or the outlet ports 606 are welded to the thermal management module 603, and in some examples, the thermal management module 603 is cast or otherwise fabricated (e.g., by additive manufacturing, injection molding, casting, or another suitable fabrication technique) to include the inlet port 605 and outlet ports 606.

A thermal management module including channels for fluid flow can be integrated into other portions of an electrochemical cell, e.g., in addition to or instead of the lid. For instance, a thermal management module can be incorporated into the interior surface of one or both of the largest faces of the cell, e.g., the side face 106 defined by the length L and height H of the cell (see FIG. 1). The inclusion of a thermal management module on the side face(s) of the cell can help to reduce heat flow from an overheating cell to other, neighboring cells an array, e.g., because the largest faces of the cells face one another in an array.

In some examples, a thermal management module can provide thermal management through mechanisms other than heat transfer to or from a fluid. For instance, the thermal management module can be a thermoelectric module that converts waste heat into an electric current. The thermoelectric module can be disposed on one or both lids of an electrochemical cell, on one or both of the largest side faces of the electrochemical cell, or both.

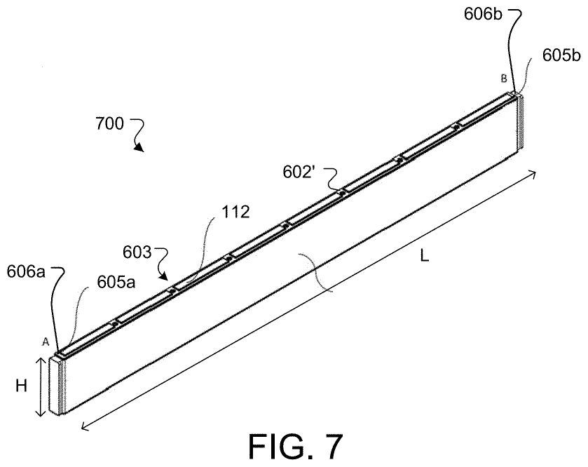

FIG. 7 is a perspective view of an electrochemical cell 700 including a lid 602′ with thermal management module 603 of FIGS. 6A-6B. An inlet port 605a and an outlet port 606a are provided in the ‘A’ position, and a second inlet port 605b and outlet port 606b are provided in the ‘B’ position. In this configuration, the fluid flows through the fluid channels along the entire length L of the cell unit in both directions, e.g., from ‘A’ to ‘B’ and from ‘B’ to ‘A.’ This configuration provides a smooth and substantially symmetric thermal gradient along the length L of the electrochemical cell 700.

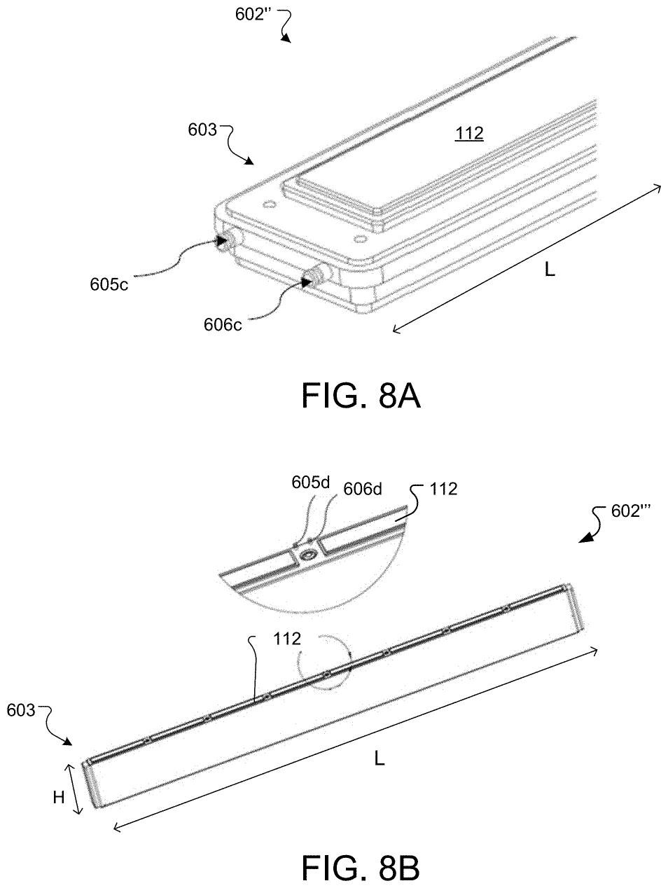

FIG. 8A is a perspective view of an electrochemical cell lid 602″ with the thermal management module 603 of FIGS. 6A-6B, showing an example arrangement of an inlet port 605c and outlet port 606c of the thermal management module 603. In FIG. 8A, the inlet port 60c5 and the outlet port 606c are provided on the same end of lid 602″, such that the fluid flows through the fluid channels along all or a portion of the length L, and then doubles back to exit on the same side where it entered. In some examples of this configuration, the fluid channels are configured such that the fluid flows along the entire length L of the electrochemical cell before doubling back. In some examples, multiple fluid channels are defined, with a first channel defining a flow path starting from one end of the lid, reaching approximately the mid-point of the length, and returning to same end, and a second channel defining a flow path starting from the other end of the lid, reaching approximately the mid-point of the length, and returning to that same other end. This configuration can be useful, e.g., for managing high thermal loads.

FIG. 8B is a perspective view of an electrochemical cell 800 including a lid 602′″ with the thermal management module 603 of FIGS. 6A-6B, showing an example arrangement of an inlet port 605d and outlet port 606d of the thermal management module 603. In this configuration, the inlet port 605d and outlet port 606d are adjacent to one another at approximately the midpoint of the length of the electrochemical cell. In some examples of this configuration, a single fluid channel extends from the inlet port 605d, to one end of the cell unit, doubles back and reaches the opposite end of the electrochemical cell, and then doubles back again to return to the outlet port 606d. In some examples, multiple pairs of inlet and outlet ports can be disposed along the length L of the electrochemical cell such that the flow path between each pair of inlet and outlet ports is short, e.g., enabling high thermal loads to be managed.

The positioning of the inlet port and outlet port is based on, e.g., expected thermal management needs, the dimensions of the electrochemical cell, or other design criteria. Other positions of the inlet and outlet ports, and other configurations of the fluid channel(s), are also possible.

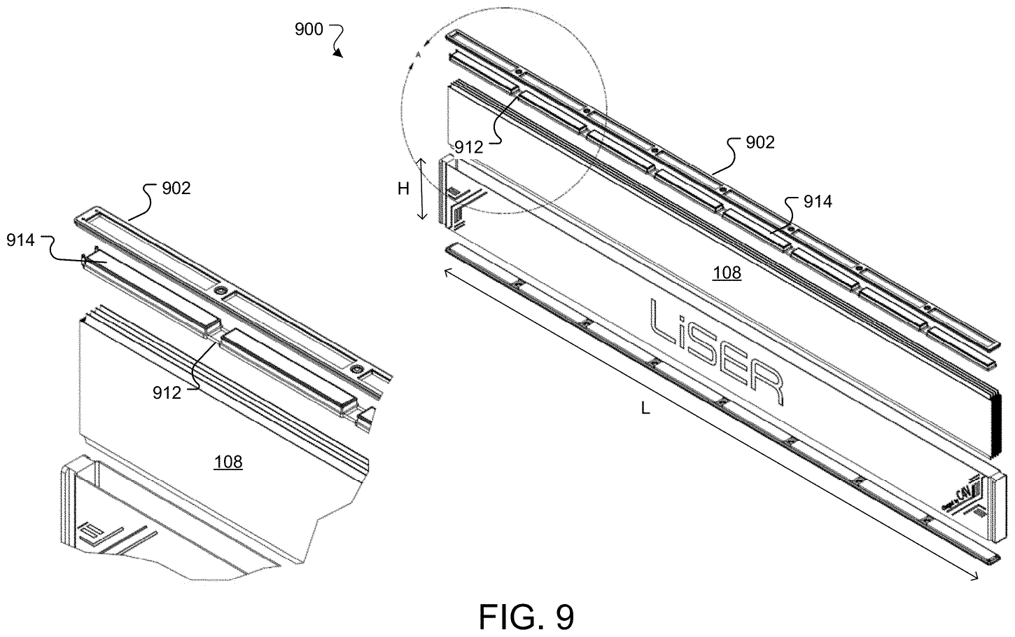

Although in the example of FIGS. 6A-6B, the fluid channels of the thermal management module 603 are defined within the body of the lid 602 such that the interior surface 601 of the lid 602 is planar, other configurations are possible. For instance, referring to FIG. 9, a lid 902 of an electrochemical cell includes a thermal management module 903 that includes a tube 912, such as a metal tube (e.g., a copper tube), which is attached to an inner surface of the lid 902. The tube 912 runs along the length of the electrochemical cell and extends between conductive terminals 914 to which the anode and cathode layers in the electrochemical cell are attached. Fluid enters into and exits from the tube 912 via an inlet port and an outlet port, e.g., as described above.

In some examples, both the lid to which the cathode layers are connected and the lid to which the anode layers are connected include a thermal management module. In some examples, only one lid includes a thermal management module, e.g., relevant for applications in which a relatively low thermal load is expected. In some examples, when both the cathode layers and anode layers are connected to the same lid, the wall of the housing that is opposite that lid includes a thermal management module 3.

In operation (e.g., when the electrochemical cell is in use generating an electrochemical current), fluid (e.g., a liquid, a gas, or a combination thereof) is flowed into each of one or more inlet ports, through a fluid channel connected to each inlet port, and out a corresponding outlet port. As the fluid flows through the fluid channel, heat is transferred between the fluid and the electrolyte in the interior of the electrochemical cell. For instance, when the fluid is a cooling fluid, heat is transferred to the fluid from the electrolyte; when the fluid exits through the outlet port, heat is thus removed from the electrochemical cell. When the fluid is a heating fluid, the fluid provided into the fluid channels is at a higher temperature than the interior of the electrochemical cell. As the fluid flows through the fluid channel, heat is transferred from the fluid to the electrolyte in the interior of the electrochemical cell, e.g., heating the electrolyte to enable efficient start-up or operation of the electrochemical cell.

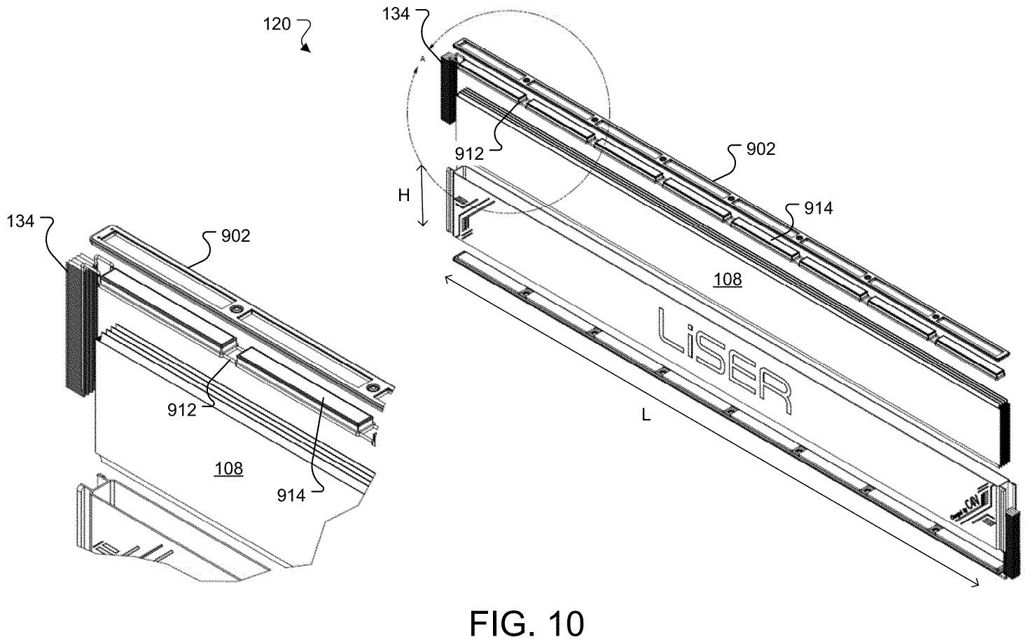

Referring to FIG. 10, in some examples, a passive cooling system is integrated with a thermal management module. FIG. 10 illustrates an electrochemical cell 120 including a passive cooling system 134 integrated with the lid 902 of FIG. 9. The lid 122 has a thermal management module 123 including a tube 132, e.g., as described above for FIG. 9, and a passive cooling system 134; however, the passive cooling system is applicable also to other types of thermal management modules, e.g., the thermal management module 603 of FIG. 6. The tube 132 extends along the passive cooling system 134 such that the fluid flowing through the tube 132 can be cooled or heated by thermal transfer with the passive cooling system 134. For instance, the passive cooling system 134 can be a fin structure.

Referring again to FIG. 2, the cathode layers 201 and anode layers 203 are each formed from a metal substrate (e.g., foil) with an cathode active material or anode active material, respectively, coated on one or both surfaces of the substrate. In some examples, to enable a direct connection between the cathode layers 201 and the lid 102a, and between the anode layers 203 and the lid 102b, the ends of the cathode layers and anode layers closest to the inner surface 210a of the lid 102 to which they are connected are uncoated, e.g., the ends of the cathode and anode layers are metal substrate with substantially no anode or cathode active material coated thereon. This tab-less, direct connection between the anode and cathode layers and the inner surface 210a of the respective lid is a configuration that has low electric resistance and high conduction of current between each of the cathode and anode and the respective lids, e.g., enabling fast charging and discharging of the electrochemical cell. For instance, electrochemical cells with this tab-less, direct connection have greater efficiency than electrochemical cells having welded or non-welded tabs. The tab-less connection arrangements described here can be used in conjunction with the fluid management module 3 described above or can be used without a fluid management module.

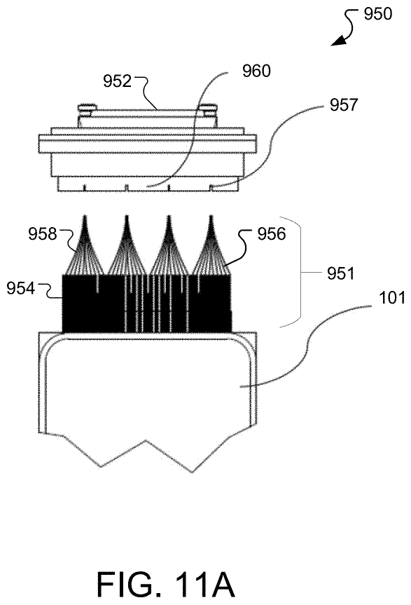

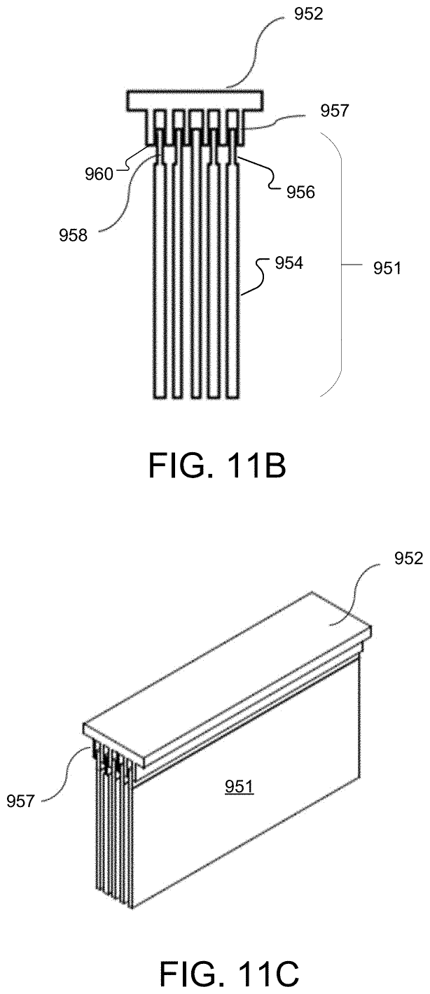

FIGS. 11A-11C illustrate interior views of a portion of an electrochemical cell 950 including vertical, direct (e.g., tab-less) connections between an interior surface 960 of a lid 952 and the uncoated substrates of the electrodes disposed in the housing 101. In the example of FIGS. 9A-9D, the current collectors are cathode layers 951; however, a similar configuration also applies to anode layers.

Each cathode layer 951 includes a coated portion 954 and an uncoated portion 956. The coated portion 954 of each cathode layer 951 is a metal substrate coated with an anode active material. The uncoated portion 956 of each cathode layer 951 is the metal substrate, with substantially no cathode active material disposed thereon, e.g., such that the metal substrate is exposed. The uncoated portions 956 of multiple cathode layers 951 are clubbed together into a narrow cathode tip 958, which is directly connected to the interior surface 960 of the lid 952. Similarly, although not shown, each anode layer includes a coated portion including a metal substrate coated with a anode active material, and an uncoated portion including the metal substrate with substantially no anode active material disposed thereon. The uncoated portions of the anode layer are clubbed together into narrow anode tips, which are directly connected to the terminal interior surface of the corresponding lid.

In the example of FIGS. 11A and 11B, the cathode tips 958 including the uncoated portions 956 of the cathode layers 951 are fitted into corresponding grooves 957 that are defined on the interior surface 960 of the lid 952. The grooves 957 extend along the length of the lid 952, e.g., along the length of the electrochemical cell. For instance, when the cathode layers and anode layers are connected to opposing lids, the cathode tips 958 including the uncoated portions 956 of the cathode layers 951 are fitted into the grooves 957 on one lid, whereas the anode tips including the uncoated portions of the anode layers are fitted into grooves on the opposing lid. The separator layers between the anode and cathode layers (see FIG. 2) do not contact the lids. The fitting of the uncoated portions of the cathode and anode layers into the grooves can be by welding (e.g., laser welding, etc), pressure fitting, or another suitable connection mechanism.

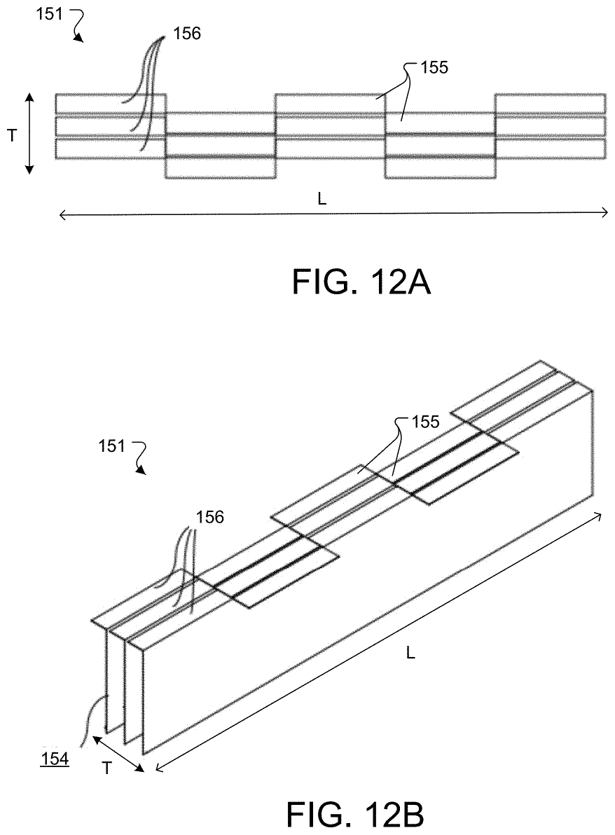

FIGS. 12A and 12B illustrate a top view and a perspective view, respectively, of cathode layers 151 in an example horizontal, direct (e.g., tab-less) arrangement for connection to the inner surface of a lid of an electrochemical cell. A similar configuration can apply to the anode layers. Each cathode layer 151 includes a coated portion 154 and an uncoated portion 156, as discussed above. The uncoated portions 156 of the cathode layers 151 are angled relative to the coated portions 154, e.g., the uncoated portions 156 are substantially perpendicular to the coated portions 154. These angled uncoated portions 156 form protrusions that extend in a direction of the thickness T of the electrochemical cell. In the illustrated example, each cathode layer 151 includes multiple protrusions extending in alternating, opposing directions along the length of the electrochemical cell. In some examples, all of the protrusions are oriented in the same direction. The plane of the protrusions is parallel to the plane of the terminal interior surface of the lid, and an exterior surface 155 of the protrusions (e.g., the uncoated metal foil) contacts the terminal interior surface of the lid. For instance, the exterior surface 155 of the protrusions is connected, e.g., laser welded, to the terminal interior surface of the lid.

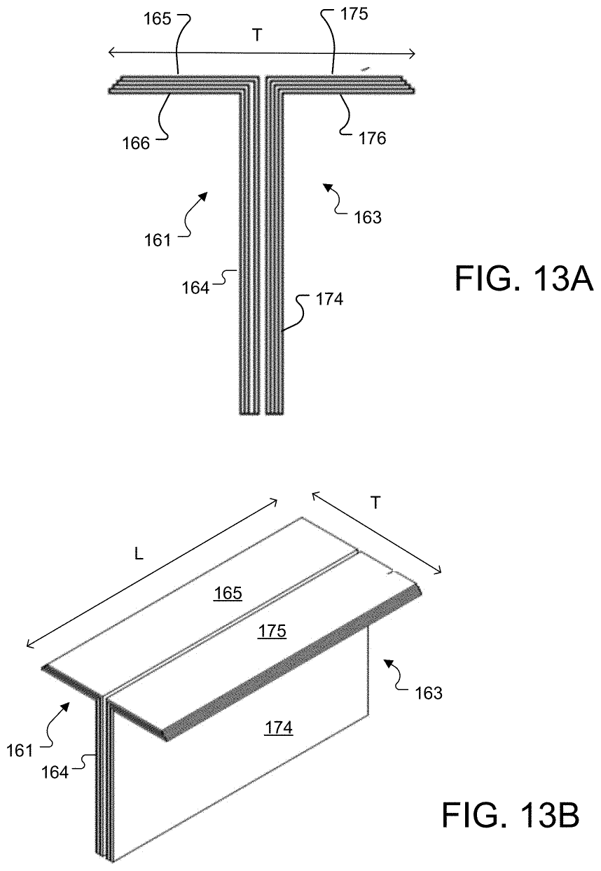

FIGS. 13A and 13B illustrate an end view and a perspective view, respectively, of cathode layers 161 and anode layers 163 in an example horizontal, wing-based, direct (e.g., tab-less) arrangement for connection to a lid. Each anode layer 161 includes a coated portion 164 and an uncoated portion 166, as discussed above. Similarly, each anode layer 163 includes a coated portion 174 and an uncoated portion 176.

The uncoated portions 166 of the cathode layers 161 are angled relative to the coated portions 164, e.g., the uncoated portions 166 are substantially perpendicular to the coated portions 164. The angled uncoated portions 166 of multiple cathode layers 161 form an cathode protrusion that extends in a first direction along the thickness T of the electrochemical cell. The uncoated portion 166 of the central-most cathode layer forms an exterior surface 165 of the cathode protrusion. The uncoated portions 176 of the anode layers 163 are angled relative to the coated portions 174, e.g., the uncoated portions 176 are substantially perpendicular to the coated portions 174. These angled uncoated portions 176 form a anode protrusion that extends in a second direction along the thickness T of the electrochemical cell, and opposite the first direction of the cathode protrusion. The uncoated portion 176 of the central-most anode layer forms an exterior surface 175 of the anode protrusion.

The plane of the protrusions is parallel to the plane of the terminal interior surface of the lid, and the exterior surfaces 165, 175 (e.g., the uncoated metal foils) contact respective portions of the interior surface of the lid. For instance, the exterior surfaces of the protrusions are connected, e.g., laser welded, to the interior surface of the lid.

In some examples, the configuration of FIGS. 13A-13B is applicable to cathode layers alone, e.g., some of the cathode layers are folded to form a first protrusion extending in a first direction and the remaining cathode layers are folded to form a second protrusion extending in a second direction opposite the first direction. A similar structure can apply to the anode layers, for connection to an opposing lid.

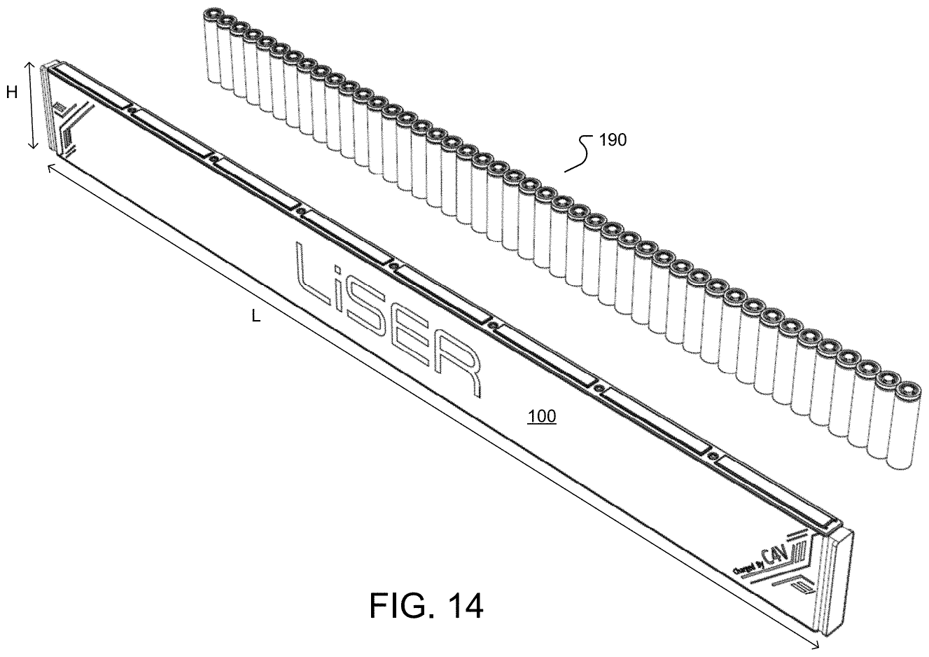

Referring to FIG. 14, in some examples, the elongated electrochemical cell 100 (or another electrochemical cell as described here) can be implemented as a replacement to an array 190 of cylindrical cells. A suitably dimensioned electrochemical cell 100 can be dropped into a slot to replace a one dimensional array of cylindrical cells, e.g., without requiring reengineering of the slot. For instance, an electrochemical cell having a length of 800 mm and a height of 18 mm can replace 44 18650 cylindrical cells.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

What is claimed is:

1. An electrochemical cell comprising:
a housing defining an interior space of the electrochemical cell;
a lid disposed on a first face of the electrochemical cell defined by a length and a thickness of the housing, in which a dimension of the housing extending perpendicular to the first face of the electrochemical cell is a height of the housing, and in which the length of the housing is greater than the height of the housing;
an anode and a cathode disposed in the interior space of the electrochemical cell, at least one of the anode or the cathode connected to the lid.

2. The electrochemical cell of claim 1, in which the lid is a first lid, and in which the electrochemical cell comprises:
a second lid disposed on a second face of the electrochemical cell opposite the first face, the second lid separated from the first lid by the height of the housing, and
in which the anode is connected to the first lid and the cathode is connected to the second lid.

3. The electrochemical cell of claim 1, in which a ratio between the length of the housing and the height of the housing is greater than 1 and less than 40.

4. The electrochemical cell of claim 1, in which the height of the housing is less than 500 mm.

5. The electrochemical cell of claim 4, in which the height of the housing is less than 125 mm.

6. The electrochemical cell of claim 1, in which the length of the housing is at least 100 mm.

7. The electrochemical cell of claim 6, in which the length of the housing is greater than 500 mm.

8. The electrochemical cell of claim 7, in which the length of the housing is greater than 1 meter.

9. The electrochemical cell of claim 1, in which the electrochemical cell is configured such that current flow in the electrochemical cell is substantially in a direction parallel to the height of the electrochemical cell.

10. The electrochemical cell of claim 1,
in which the lid comprises multiple electrically conductive sections, in which each first section is electrically isolated from each other section.

11. The electrochemical cell of claim 10,
in which the cathode comprises multiple cathode elements, in which a corresponding subset of the cathode elements is connected to each section of the lid.

12. The electrochemical cell of claim 10,
in which the anode comprises multiple anode elements, in which a corresponding subset of the anode elements is connected to each section of the lid.

13. The electrochemical cell of claim 12, in which multiple sub-cells are defined within the interior of the space of the electrochemical cell, each sub-cell containing a respective subset of the anode elements.

14. The electrochemical cell of claim 13, in which each sub-cell is fluidically isolated from each other of sub-cell.

15. The electrochemical cell of claim 13, in which at least one sub-cell has a performance characteristic that differs from a performance characteristic of one or more other of the sub-cells.

16. The electrochemical cell of claim 13, in which at least one sub-cell is controllable independently from one or more other of the sub-cells.

17. The electrochemical cell of claim 1, in which a fluid channel is defined on an inner surface of the lid.

18. The electrochemical cell of claim 1, in which the anode comprises:
a metal substrate extending along the height of the electrochemical cell; and
an anode material coated on a portion of a surface of the metal substrate, and
in which an uncoated portion of the metal substrate is in contact with an inner surface of the lid.

19. The electrochemical cell of claim 1, in which the cathode comprises:
a metal substrate extending along the height of the electrochemical cell; and
a cathode material coated on a portion of a surface of the metal substrate, and
in which an uncoated portion of the metal substrate is in contact with an inner surface of the lid.

20. A battery pack comprising an array of the electrochemical cells of claim 1.

21. The battery pack of claim 20, in which the electrochemical cells in the array are arranged such that a largest face of each electrochemical cell faces a largest face of an adjacent electrochemical cell.

22. The battery pack of claim 20,
in which the lid comprises a first lid to which the anode is connected, and in which each electrochemical cell comprises a second lid disposed on a second face of the electrochemical cell opposite the first face, in which the cathode is connected to the second lid, and
in which the electrochemical cells in the array are arranged such that the first lid of a first electrochemical cell in the array faces in a first direction, and the first lid of an adjacent electrochemical cell in the array faces in a second direction opposite the first direction.

23. The battery pack of claim 20, in which the battery pack is disposed in a vehicle.

24. The battery pack of claim 23, in which the battery pack is disposed in the vehicle such that the length of the electrochemical cells in the battery pack is oriented parallel to an axle of the vehicle.
